(19) United States
(12) Patent Application Publication
(10) Pub. No.: US 2002/0157117 A1
(43) Pub. Date: Oct. 24, 2002

(54) Method and apparatus for video insertion loss equalization

(76) Inventors: Jacob Geil, Irvine, CA (US); Steve Somers, Chino Hills, CA (US)

Correspondence Address: THE HECKER LAW GROUP, 1925 CENTURY PARK EAST, SUITE 2300, LOS ANGELES, CA, 90067, US

(21) Appl. No.: 09/800,567

(22) Filed: Mar. 6, 2001

(51) Int. Cl. H04N 7/16

(52) U.S. Cl. 725/139; 725/141; 725/151; 348/557

(57) ABSTRACT

A method and apparatus for compensating for video insertion loss due to transmission over long coaxial cable lines is presented. An Electro-Magnetic Interference suppression type filter having a ferrite core is used to simulate and thereby compensate for the effect of the cable insertion loss on video transmitted over long coaxial cables. The Electro-Magnetic Interference suppression filter has a frequency response similar to the insertion loss characteristics of a coaxial cable, especially at the low to mid frequency range, where it has been traditionally difficult both in cost and in complexity to compensate because of the frequency response characteristics of the coaxial cable. High frequency compensation is also added using a voltage variable capacitance diode device to extend the total compensated video bandwidth to beyond 200 megahertz.

### BACKGROUND OF THE INVENTION

1. Field of the Invention

This invention relates to the field of video insertion loss equalization. More specifically the invention relates to compensating for losses in analog video quality due to transmission line length.

2. Background Art

Video cables are used to convey electronic video signals from a source device such as a receiver to a destination, typically a display device. A cable is supposed to accurately convey the signal, however, losses accumulate along the cable path because of imperfections in a transmission cable. These imperfections are not necessarily due to manufacturing but due to the fact that a cable is a physical device and most physical devices exhibit some losses when a signal is transmitted through them. Thus, the longer the cable length, the more losses accumulate. The accumulated transmission loss is known by those of skill in the art as cable insertion loss. Of course, other devices switches and splitters in a video transmission path contribute to the total video loss however only coaxial cable insertion losses are considered in this specification.

Video may be transmitted either in digital or analog formats. For digital video transmission such as computer video, cable insertion loss is generally not an issue because the digital signal can be recovered so long as discernable digital pulses are received at the receiving station. However, for analog signals such as NTSC (National Television Standards Committee) video, the signal is just voltages, and voltages are affected by wire length, connectors, heat, cold, and other conditions. This degrading effect on the video signal caused by the transmission cable length is known as cable insertion loss.

Analog video such as the C-Video, S-Video, or YUV (or YIQ) specifications may be available in any of the different color models. A color model (also color space) facilitates the specification of colors in some standard, generally accepted way, for example, the RGB color model where R is for the red component, G is for the green component, and B is for the blue component. For high-resolution analog video, each color component is usually transmitted separately from the receiver to the display device. Thus, each color component must be examined for cable insertion losses.

Cable insertion loss can be characterized as a function of frequency (i.e., rate of the video input). FIG. 1 illustrates such characteristics for 100 feet, 200 feet, and 300 feet of super high-resolution (SHR) cable lengths. Insertion loss is specified in decibels (dB). As shown in the illustration of FIG. 1, the insertion loss is approximately 0 dB at zero frequency, i.e., the output will be approximately equal to the input if the input is constant for a long period of time. In addition, the insertion loss increases as the input frequency increases. Also, longer cable lengths have more insertion loss, e.g., the 300 feet cable has approximately 11.4 dB loss at 300 megahertz while the 100 feet cable only has an approximate 4 dB loss at the same frequency. Thus, the video insertion loss increases as the cable length over which the analog video is transmitted increases. This is why compensation is generally not needed and usually not applied for short cable runs, e.g., six feet.

Several compensation techniques may be used to compensate for cable insertion losses, however, in broadband systems where signals range from the steady state to several hundred megahertz, it is nearly unfeasible in terms of cost to compensate the entire frequency spectrum (typically 0-300MHz). It is particularly problematic because of the shape of the frequency response characteristics of the insertion loss which shows rapid drop off in the low frequency range (0-15 MHz) and then followed by a shallow drop over the remainder of the frequency range. The insertion loss characteristics at the low frequency are due to diffusion in the cable. Different cables, type or length, have different diffusion rates. The insertion loss characteristics at the high frequency ranges are due to a phenomenon known as skin effect. Skin effect takes over as the video input frequency increases thereby resulting in high frequency skin losses which are basically linear. Current industry methods effectively compensate for the high frequency end of the spectrum but not the low frequency end because of the complex frequency response characteristics associated with insertion loss over coaxial cables. The problem with compensating for high frequency losses without compensating for the low frequency losses in video transmitted over long coaxial cable is that people are more tolerant to seeing less sharp pictures (high frequency effects) so long as they can see the information. However, people are least tolerant of low frequency anomalies which are characterized by distortion or smearing type phenomenon across the video screen.

FIG. 2 is an illustration of a setup for a video display from a source signal to a destination display device. The input video signal is V_{IN}, and the output video signal displayed on display screen 200 is V_{OUT}. As discussed earlier, video input signal V_{IN} is an analog voltage signal thus video amplifier 204 is used in a video receiver to condition the voltage to the level desired by the display device. Generally, video amplifier 204 conditions the analog video input signal to compensate for transmission line loss such that the proper video signal reaches display device 200. Block 208 is an operational amplifier gain and block 206 is the current feedback gain (generally representing resistive dividers). The feedback is from the output of the operational amplifier through resistors (represented by block B 206) to the negative input terminal of the operational amplifier. Thus, in this configuration, the transfer function between the input and output voltage of the video amplifier is A/[1+AB].

Coaxial cable line 202 represents the total cable length the video must travel from the input source to display device 200. Thus, assuming there is no change in voltage at video amplifier 204, FIG. 1 would represent the frequency responses between input signal V_{IN} and output signal V_{OUT} for different cable lengths. A change in voltage would be represented by a non-zero amplitude bias at the zero frequency point.

FIG. 3 shows the transient response characteristics of a 200 feet super high-resolution coaxial cable. Using FIG. 2 as an illustration, a step input (e.g., 300), which is characterized as having frequency content from zero to approximately infinity, is introduced at V_{IN}. The transient response output V_{OUT} (e.g., 310) is shown in FIG. 3. Region 320 represents the low frequency diffusion effects while region 330 represents the high frequency skin effects of the coaxial cable. The effect of the low frequency characteristic of the coaxial cable is also evidenced by the large rise time of 19.06 nanoseconds. Large rise time is synonymous with low bandwidth. Thus, the coaxial cable introduces a low bandwidth filter effect on the input video signal passing through it. Generally, rise time increases with decreasing characteristic bandwidth and longer cable lengths tend to produce lower characteristic bandwidth.

To illustrate the filter effect of the coaxial cable, FIG. 4 shows a low pass filter being used as an example to represent the effect of cable line 202 of FIG. 2. Using low pass filter 400 with bandwidth of representing the characteristic bandwidth of the cable length, V_{OUT} is given by the equation:

$${V}_{OUT} = \frac{A}{[ 1 + AB ]} \frac{1}{[ \frac{1}{ω} s + 1 ]} {V}_{IN}$$

Thus, the goal is to make bandwidth ω as large as possible such that the frequency response between the input and output videos will remain as flat as possible to a frequency high enough that any distorting effects are not discernable by the human eye. One way to compensate for the effect of the low bandwidth ω of the cable characteristics is to include the coaxial cable line loss in the feedback loop as shown in FIG. 5. Thus, instead of the current feedback originating directly from the output of video amplifier 504, cable characteristic 400 is included in the closed loop and thereby compensated for in video amplifier 504. The resulting transfer function between input V_{IN} and output V_{OUT} is given as follows:

$${V}_{OUT} = \frac{A}{[ 1 + AB ]} \frac{1}{[ \frac{1}{( 1 + AB ) ω} s + 1 ]} {V}_{IN}$$

Thus, the new bandwidth between the input and output voltage is increased by the factor (1+AB) and thus directly controllable by the gains chosen for the video amplifier feedback. However, this implementation would require feedback from a long (e.g., 200 feet) cable back to the video (i.e., operational) amplifier 504 which is located at the source. Firstly, this is impractical and secondly there is a significant amount of time delay involved in feeding back from the long cable runs. For example, FIG. 6 shows that a 200 feet coaxial cable has approximately two hundred and sixty (260) nanosecond delay. Long feedback delays tend to cause loop instability and thus limits the loop gains that can be used in the video amplifier. The most practical way of compensating for the cable insertion loss characteristics is to duplicate those characteristics in the feedback path as shown in FIG. 7 thus eliminating the time delay involved in feeding back from a long cable run.

FIG. 7 illustrates the most practical way of compensating for cable insertion loss. Mathematically, this provides the same results as FIG. 5 above, i.e., the loop bandwidth is increased by [1+AB]. In a perfect situation, Block 700 replicates the cable characteristics. However, cost prohibitions make it impractical to create analog circuitry for block 702 in video amplifier 700 that duplicates the cable insertion loss characteristics 400 in a wide frequency range as shown in FIG. 1. Thus, current implementations tend to do a good job compensating for the high frequency losses but not the low frequency losses.

### SUMMARY OF THE INVENTION

This invention defines a method and apparatus for enhancing or improving the quality of high-resolution video images by compensating for the losses caused by transmission of the video signal over long coaxial cables. The loss that occurs during transmission of the video signal is known as cable insertion loss. In one embodiment of the invention, an Electro-Magnetic Interference (EMI) suppression type filter having a ferrite core is used to simulate and thereby compensate for the effect of the cable insertion loss on video transmitted over long coaxial cables. The EMI suppression filter has a frequency response similar to the insertion loss characteristics of a coaxial cable, especially at the low to mid frequency range, where it is especially difficult both in cost and in complexity to compensate because of the atypical frequency response characteristics of the coaxial cable.

In another embodiment of the present invention, high frequency compensation is added using a voltage variable capacitance diode device to extend the total compensated video bandwidth to beyond 200 megahertz. Other embodiments provide for independent compensation and adjustment of the low and high frequency ranges.

### BRIEF DESCRIPTION OF THE DRAWINGS

FIG. 1 is an illustration of the frequency response characteristics of 100 feet, 200 feet, and 300 feet super high-resolution coaxial cable.

FIG. 2 is an illustration of a schematic for typical video display originating from a source signal to a destination display device.

FIG. 3 is the transient response characteristics of a 200 feet super high-resolution coaxial cable.

FIG. 4 is an illustration using a low pass filter to represent the effect of cable insertion loss characteristics.

FIG. 5 is an illustration of a technique to compensate for the effect of the insertion loss through the coaxial cable by including the entire coaxial cable line in the video amplifier feedback loop.

FIG. 6 shows the time delay inherent in a 200 feet coaxial cable as a function of frequency.

FIG. 7 is an illustration of a technique to compensate for the effect of the insertion loss through the coaxial cable by including the characteristic effects of the coaxial cable line in the video amplifier feedback loop.

FIG. 8 is a frequency response plot of an EMI suppression filter having a ferrite core with multiple coil windings.

FIG. 9 is a magnification of the frequency response characteristics of a 200 feet super high-resolution coaxial cable in the low frequency range.

FIG. 10 shows the time delay inherent in an EMI suppression filter as a function of frequency.

FIG. 11 is a schematic of a video amplifier with an EMI suppression ferrite filter included in the feedback loop to compensate for video insertion loss according to an embodiment of the present invention.

FIG. 12 is a physical implementation of a video equalizer according to an embodiment of the present invention.

FIG. 13 is the transient response of the video equalizer.

FIG. 14 is a frequency response comparison with and without the video equalizer of the present invention in the low to mid frequency range.

FIG. 15 is physical implementation of a video equalizer with both low and high frequency compensation according to an embodiment of the present invention.

FIG. 16 is a frequency response comparison with and without the video equalizer of the present invention in the entire broadband frequency range.

FIG. 17 is an illustration of loss factor versus frequency for various ferrite materials.

FIG. 18 is an illustration of impedance versus frequency for various ferrite materials.

### DETAILED DESCRIPTION OF THE INVENTION

An embodiment of the invention comprises a method and apparatus for video insertion loss equalization. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

An embodiment of the invention provides a method and apparatus for enhancing or improving the quality of video images by compensating for the loss effects of transmission line length on video quality. For instance, one embodiment of the invention uses an Electro-Magnetic Interference (EMI) suppression type filter with a ferrite core to simulate and thereby compensate for the effect of cable insertion loss on video transmitted over coaxial cable.

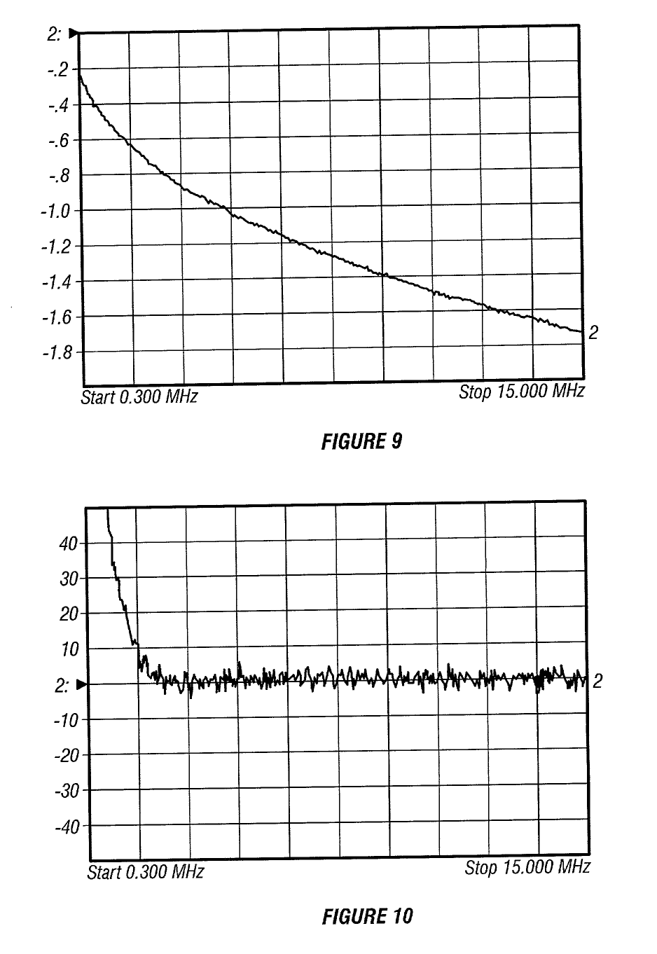

A filter of the type used for Electro-Magnetic Interference (EMI) suppression has a frequency response characteristic similar to that of a coaxial cable due to the characteristics of its ferrite core. An EMI suppression filter is generally a low-Q (quality factor) device, i.e., low bandpass filter, which has very high transmission losses. For example, FIG. 8 shows the frequency response of an EMI suppression filter with a multi-wound coil over a low-Q (i.e., EMI suppression type) ferrite core. Comparing the frequency response of an EMI suppression filter, FIG. 8, to the insertion loss characteristics of a 200 feet coaxial cable, as shown in FIG. 9, over a frequency range of 0-15 MHz shows that both systems exhibit almost identical characteristics. Thus, a filter generally used for EMI suppression may be used to compensate for cable insertion losses. This is especially useful because, as shown in FIG. 10, the EMI ferrite exhibits zero time delay, which is desirable for feedback compensation. Thus, the video amplifier loop gain is not compromised as would be if the current loop closure had included cable line 202 with its 260 nanoseconds delay.

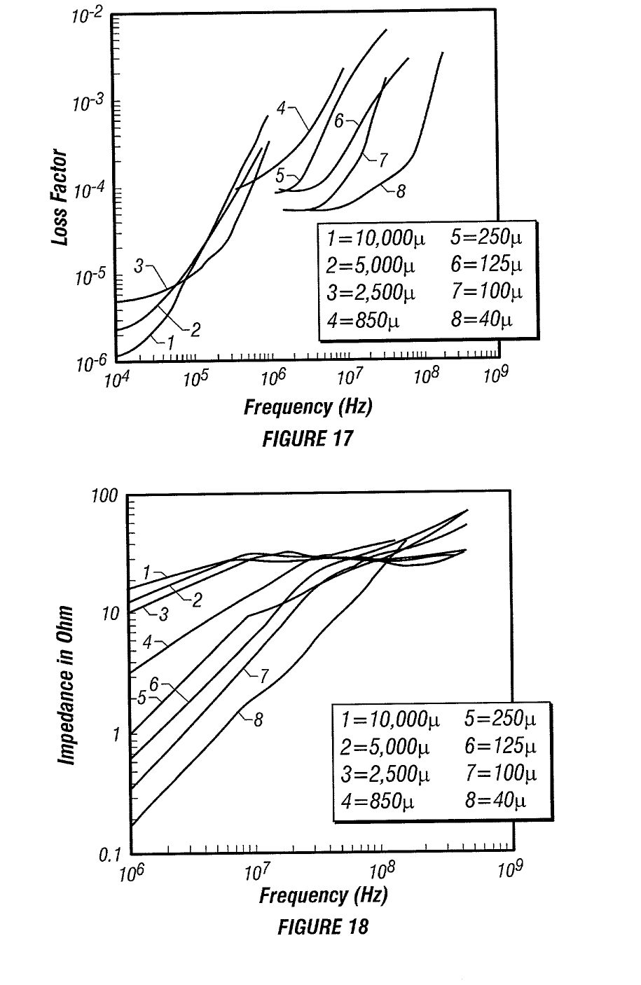

Ferrite is a class of ferromagnetic material that has a cubic crystalline structure. It is a magnetic ceramic material with a general chemical formula MO.Fe₂O₃, where MO is generally two or more divalent metal oxides compounded with iron oxide. A ferrite core acts like an inductor and a resistor in series. However, a simple inductor and resistance circuit is not conducive for broadband applications because of the inductor's relatively low resonant frequency. Thus, a high input frequency in a simple inductor-resistor circuit may result in excitation of the circuit's resonant frequency thereby causing instability. In contrast, a ferrite core becomes very lossy, i.e., highly dissipative of unwanted signals, at higher frequencies thereby eliminating any possibility of resonance. FIG. 17 is an example frequency response showing the loss factor for various ferrite materials. The ferrite materials are specified in terms of their permeability (μ). As shown in FIG. 17, the loss factor of a ferrite material is relatively constant at the low frequencies and increases exponentially as the frequency increases.

Typically, the characteristic of a ferrite is specified in terms of impedance. FIG. 18 is a frequency response showing the impedance of the various ferrite materials of FIG. 17. The impedance of a ferrite core may be regarded as a series combination of the inductive reactance and the loss resistance, both of which are frequency dependent. The impedance at the low frequencies is primarily the inductive reactance which results primarily from the material's permeability. The inductive reactance decreases as the frequency increases since permeability decreases with increasing frequency. However, the total impedance increases because of the increasing losses, thus unwanted signals are absorbed.

The appropriate ferrite core material is chosen to compensate the low to medium frequency range to avoid the self-capacitance of the material becoming an issue. Thus, any material with high impedance at the low frequencies and very good loss factor at the higher frequencies may be used as a core material for low frequency compensation in accordance with one or more embodiments of the present invention. Thus, a circuit that is basically a low pass filter with inductance-capacitance characteristics at the low frequencies and dissipative (i.e., lossy) at the higher frequencies is desirable for compensation of cable insertion losses.

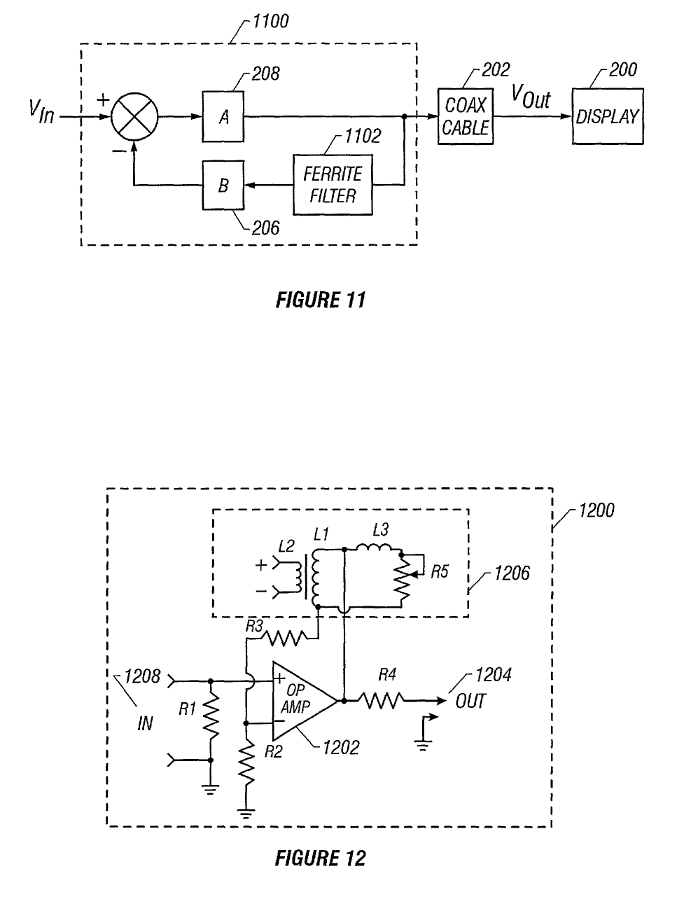

FIG. 11 is a schematic of the video amplifier with an EMI suppression ferrite filter included in the feedback loop to compensate for video insertion loss. Video equalizer 1100 includes EMI suppression filter 1102 having the characteristics of the line loss to be compensated for. Video equalizer 1100 may be located before or after cable line 202 to obtain the same effective compensation. Generally, if the equalizer is located after the cable run, then a short cable (e.g., 6 feet) is used to transmit the equalized video signal from the equalizer to the display device. Block 1102 may be a single or multi-wound low-Q EMI suppression ferrite coil. The size (e.g., length) of the ferrite core used may depend on the insertion loss to be compensated for. Thus, one or more embodiments may use different size ferrite core in compensating for losses due to transmission over different line lengths.

FIG. 12 is a physical implementation of the video equalizer according to an embodiment of the present invention. . Video Equalizer 1200 includes Operational amplifier 1202 and EMI suppression filter 1206. Operational amplifier 1202 is a typical wide band current feedback amplifier used in the video industry with flat frequency response up to approximately 300 MHz. In a typical implementation, video input 1208 may be a buffered input into video equalizer 1200 and certain types of feedback resistors (e.g., R2 and R3), which act as dividers, may be wrapped around from the output to the negative input terminal of operational amplifier 1202 to produce the broadband characteristics that is desired of video amplifiers. Also, capacitors may be added to the system to the extent desired to arrest any parasitic effects or to control the loop gain at any point in the system. Typically, operational amplifier 1200 amplifies the output voltage to a level greater than desired at a display device since some voltage drop will occur at the source impedance represented by the series output resistor R4, and in the transmission line and load at the display device end. For example, if 0.7 volts is desired at the display device end, then the feedback resistors around operational amplifier 1202 may be chosen to produce twice that voltage (i.e., 1.4 volts) because when all the losses are accounted for, the voltage at the display device end will be 0.7 volts. The steady state amplification of the input signal is by the factor (R2+R3)/R2.

Video Equalizer 1200 further includes impedance matching resistors R1 and R4. For example, R4 would be 75 Ohms where 75-ohm source impedance is desired at output 1204. EMI suppression filter 1206 comprises Coil L1, Coil L2, Coil L3, and variable resistor R5. Coil L2 is a saturation coil that may be connected to a high current DC (direct current) source for regulating low frequency losses. Coil L3 is an induction coil, preferably having a ferrite bead core, to adjust low to mid frequency bandwidth with voltage regulation from variable resistor (i.e., potentiometer) R5. Coil L1 is a low impedance coil using EMI suppression ferrite core with single or multiple windings. Coil L1 primarily compensates for cable insertion losses caused by diffusion effects in accordance with an embodiment of the present invention. Those of ordinary skill in the art would recognize that other materials could be used in place of the EMI suppression ferrite core so long as the materials produce the desired frequency response and without exhibiting a resonant peak in the frequency range of interest (e.g., 0-300 MHz).

In other embodiments of the present invention, the characteristics of the EMI suppression ferrite coil L1 may be altered as desired by partially or fully saturating the ferrite core. For example, passing a DC current through the ferrite core, either remotely, or through the operational amplifier circuitry, may produce the desired saturation of the ferrite core, thus altering the impedance characteristics and the desired frequency response.

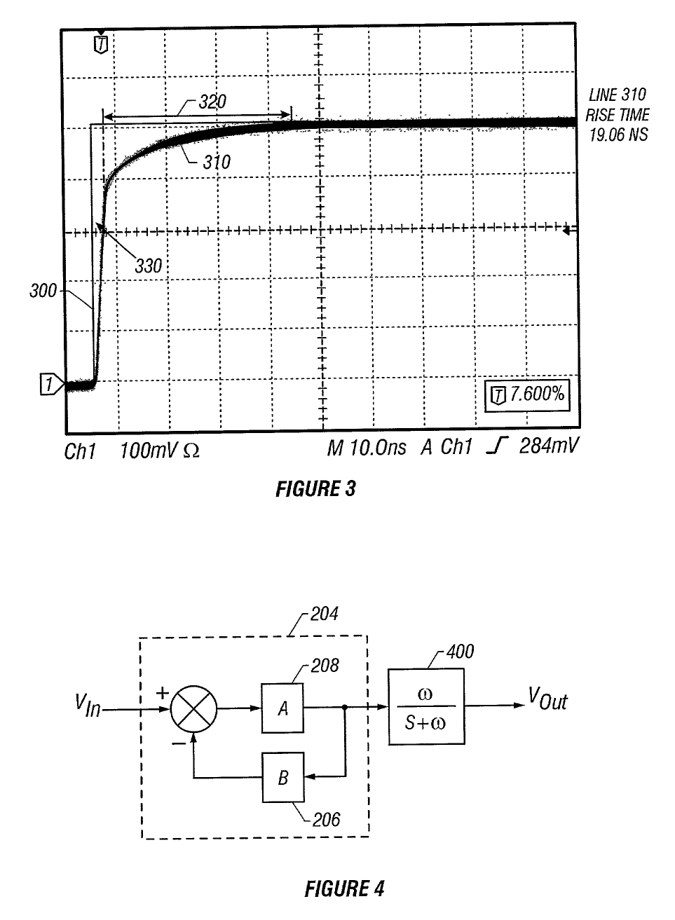

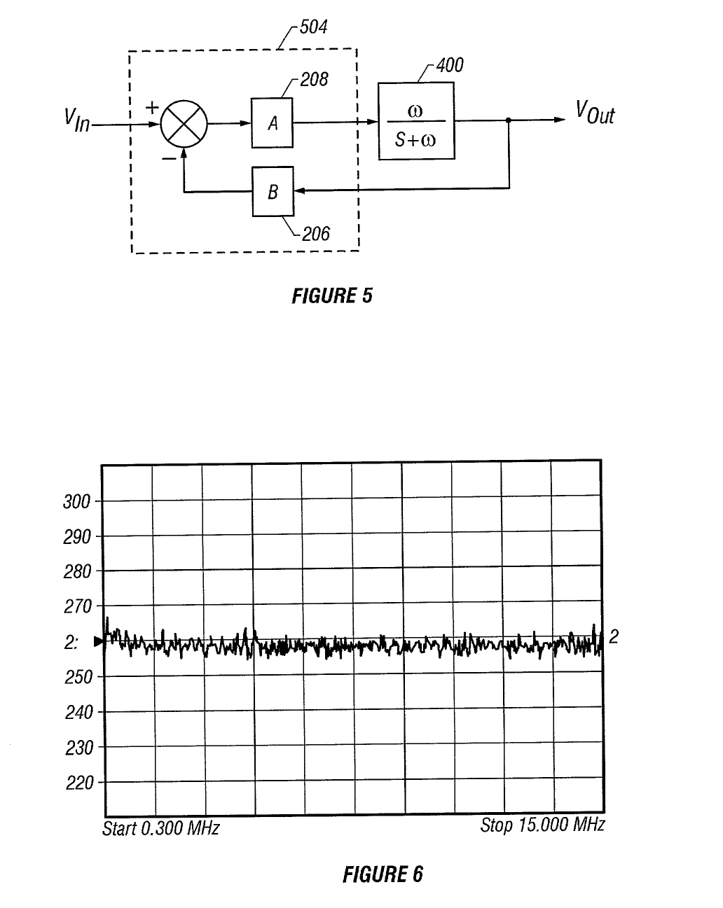

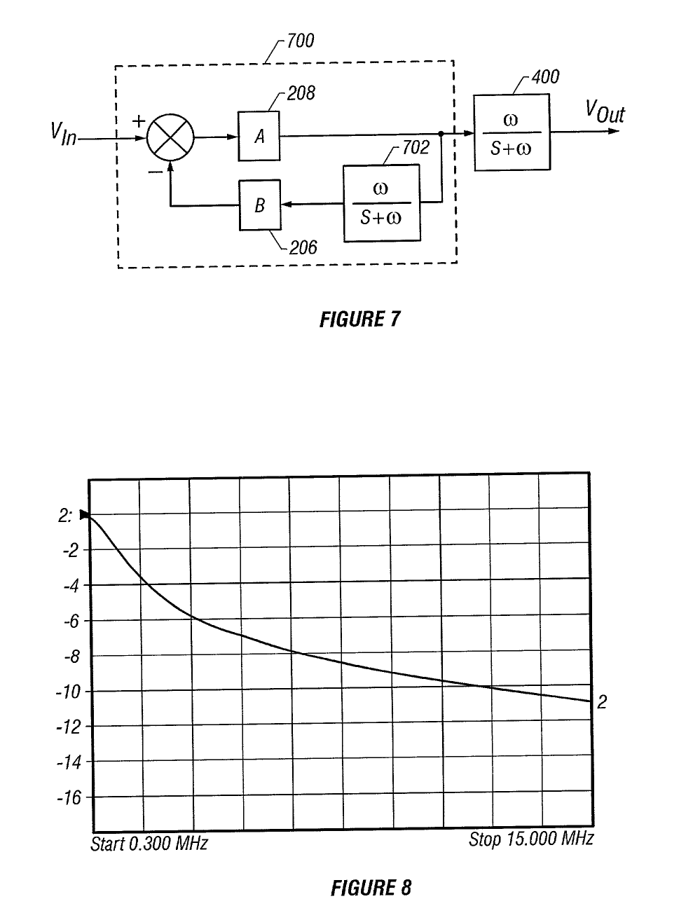

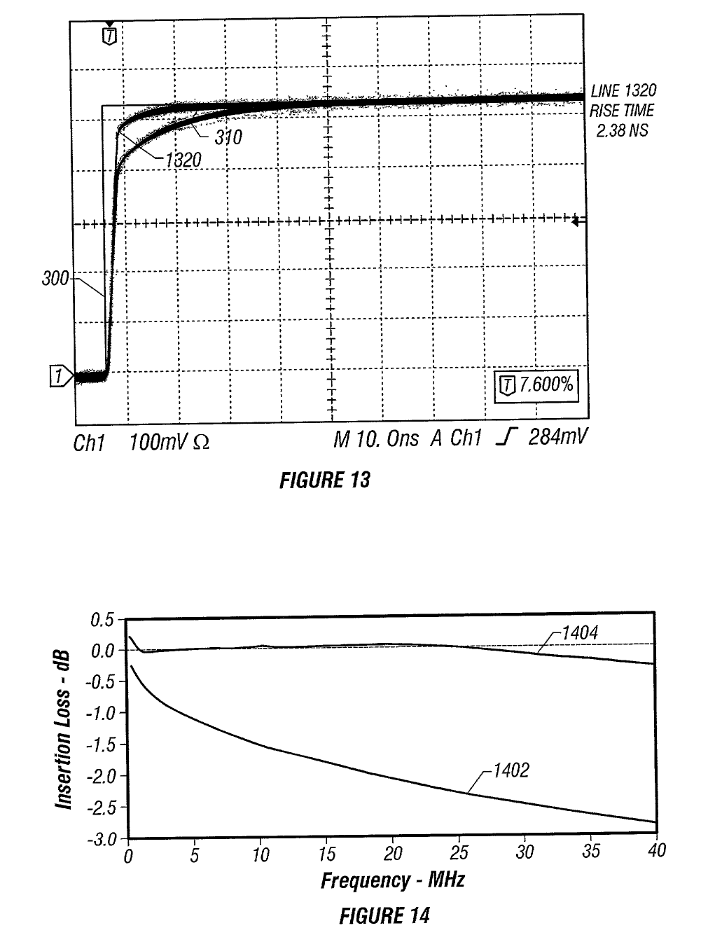

The equalized video signal resulting from adding an EMI suppression ferrite core filter is shown in FIG. 13 for transient response and in FIG. 14 for frequency response. Referring to FIG. 13, lines 300 and 310 are the same step and uncompensated transient responses, respectively, shown in FIG. 3. Line 1320 is the compensated (i.e., equalized) response using the EMI suppression filter in accordance with an embodiment of the present invention. FIG. 13 shows that there is an eight folds improvement in the equalized system 1320's rise time (2.38 nanoseconds) over the unequalized system 310's rise time of the 19.06 nanoseconds (see FIG. 3). Both the frequency (FIG. 14) and transient (FIG. 13) responses show how the EMI suppression filter effectively flattened out the characteristic response of the video signal through a 200-foot coaxial cable by significantly increasing the total loop break frequency. That is, the EMI suppression filter effectively compensates for the diffusion loss effect of the coaxial cable. Referring to FIG. 14, line 1402 is the unequalized frequency response of the high-resolution coaxial cable, and line 1404 is the equalized frequency response. FIG. 14 shows, that using the EMI suppression filter compensation of the present invention, the frequency response of the video signal through a high-resolution coaxial cable is effectively flattened out to at least 40 MHz.

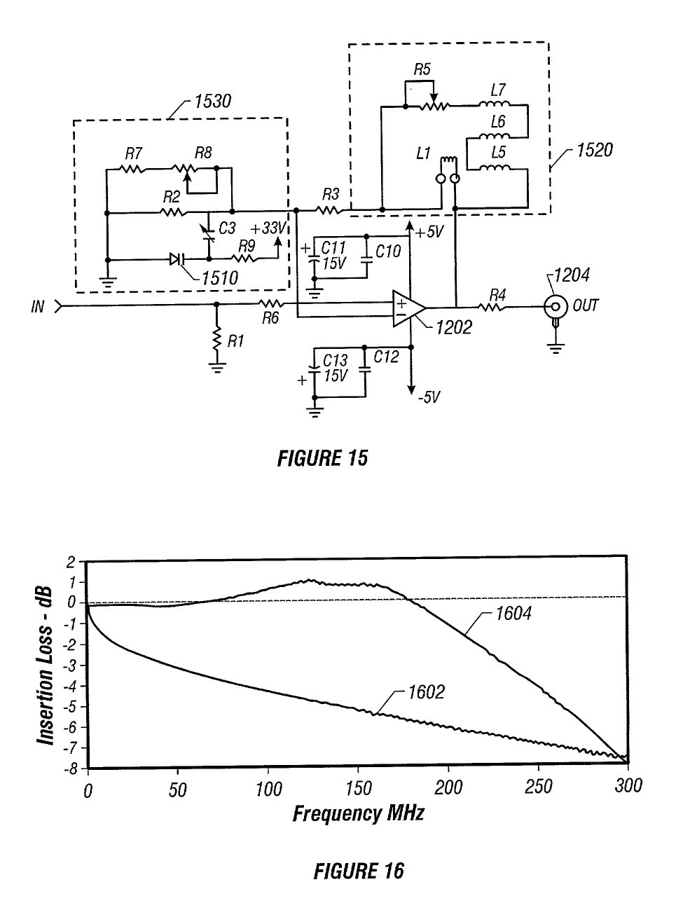

Other embodiments of the present invention may include additional compensation for the high frequency losses as shown in FIG. 15. The embodiment illustrated in FIG. 15 includes an EMI suppression filter 1520 comprising of coil L1, which uses an EMI suppression ferrite core with at least one coil winding for low to mid frequency cable insertion loss compensation, and series induction coils L5, L6, and L7, which together are equivalent to coil L3 of FIG. 12. Coils L5, L6, and L7 preferably have ferrite bead cores. Coils L5, L6, and L7 in conjunction with variable resistor R5 are used to regulate the low to mid frequency response of the video amplifier circuit. Variable resistor R5 may, for example, have 500-ohm range. In addition to the EMI suppression filter compensation circuitry, the present embodiment includes components for independently compensating the high frequency response. Although both high and low frequency compensation filters can be combined, a preferred embodiment provides independent adjustment for both.

The high frequency compensation circuit 1530 includes fixed resistor R7 (e.g., 180 ohms), variable resistor R8 (e.g., 1 k ohm range), voltage variable capacitance (a.k.a. hyperabrupt varicap) diode 1510, variable capacitor C3 (e.g., 10-40 picofarad range), and resistor R9 (e.g., 100 k ohms) around feedback resistor R2 (e.g., 270 ohms). By adjusting the variable capacitor C3 and/or variable resistor R8, the high frequency response and overshoot can be controlled. For example, capacitor C3 may control the bandwidth of the high frequency compensation filter while variable resistor R8 controls the overshoot. Capacitive circuits containing capacitors C10, C11, C12, and C13 are added to compensate for parasitic effects in the electronic circuitry. Capacitors C10 and C12 may, for example, have values of 0.01 microfarads and capacitors C11 and C13 may have values of 10 microfarads at 15 volts. Resistors R1, R4, and R6 are impedance matching resistors. For example, R4 may have a value of 75 ohms for a source impedance of 75 ohms at output terminal 1204, and resistors R1 and R6 may have values of 51 ohms and 150 ohms respectively.

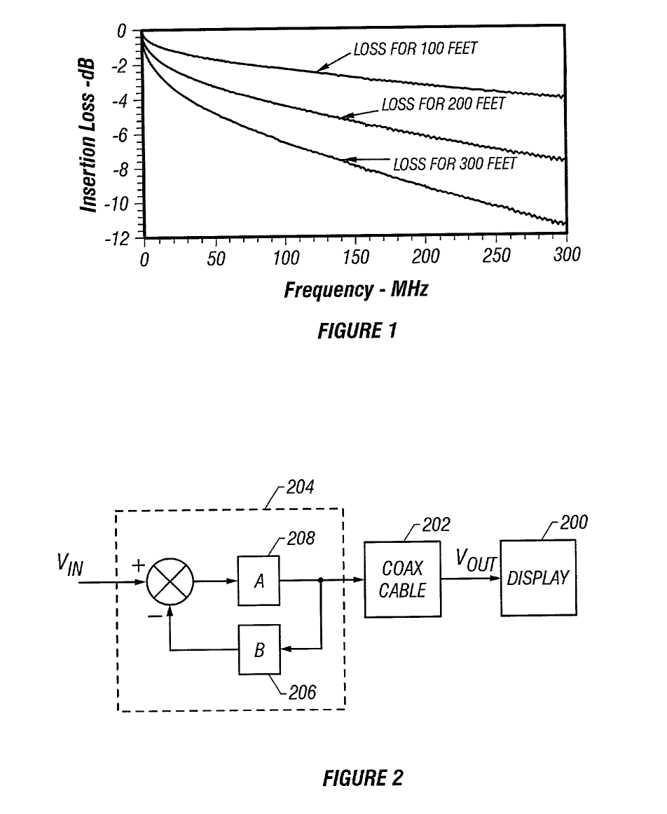

FIG. 16 shows a comparison of the compensated and uncompensated frequency responses of video transmitted over a 200 feet coaxial cable. Line 1602 is the uncompensated response similar to that shown in FIG. 1. Line 1604 is the response which includes both low and high frequency compensation filters of the present invention. This illustration shows how the methods of the present invention effectively flattened out the frequency response and thus compensated for the cable insertion loss to frequencies in excess of 200 MHz.

In practice, high-resolution video is transmitted by color components. For example, the R, G, and B components may be transmitted separately when the RGB color system is used. Also, in the CYMK color system, the C (cyan), Y (yellow), M (magenta), and K (black) components may be transmitted separately. The methods of the present invention may be applied to the individual color components or to the combined audio/video signal.

Thus, a method and apparatus for equalization of video insertion loss due to transmission over long coaxial cable lines have been described in conjunction with one or more specific embodiments. The invention is defined by the claims and their full scope of equivalents.

1. An apparatus for video insertion loss compensation comprising:
a coaxial cable of predetermined length;
an analog input video signal transmitted over said coaxial cable;
a video equalizer having an operational amplifier with feedback circuitry comprising a low pass filter with inductance-capacitance characteristics at the low frequencies and dissipative at the higher frequencies in said feedback circuitry for tailoring broadband response of said operational amplifier to generate a compensated video signal from said input video signal;
an output device for outputting said compensated video signal.

2. The apparatus of claim 1 wherein said coaxial cable is a high resolution cable.

3. The apparatus of claim 1 wherein said analog input video signal is a composite video signal.

4. The apparatus of claim 1 wherein said analog input video signal is a color component of a color system.

5. The apparatus of claim 1 wherein said operational amplifier is of the current feedback type.

6. The apparatus of claim 1 wherein said low pass filter has a coil with a ferrite core with at least one winding.

7. The apparatus of claim 6 wherein said ferrite core has high impedance characteristics at the low to medium frequencies.

8. The apparatus of claim 6 wherein said ferrite core has a size in relation to said predetermined length of said coaxial cable.

9. The apparatus of claim 8 wherein said size of said ferrite core is selected to provide the same insertion loss characteristics over a desired frequency range as said coaxial cable of predetermined length.

10. The apparatus of claim 9 wherein said frequency range is in the low to medium frequency spectrum of a broadband video signal.

11. The apparatus of claim 1 wherein said low pass filter compensates for the low to mid frequency insertion loss of said coaxial cable.

12. The apparatus of claim 11, further comprising a compensator having a high bandwidth for the high frequency range of said broadband video signal.

13. The apparatus of claim 12 wherein said compensator for said high frequency range comprises a voltage variable capacitance diode circuit with a variable capacitor for adjusting said bandwidth of said compensator.

14. The apparatus of claim 12 wherein compensation for said high frequency and said low to medium frequency range are independently adjustable.

15. The apparatus of claim 1 wherein said equalizer is located before said coaxial cable.

16. The apparatus of claim 1 wherein said equalizer is located after said coaxial cable.

17. The apparatus of claim 6 wherein said ferrite core is partially saturated from a direct current power source.

18. The apparatus of claim 6 wherein said ferrite core is fully saturated from a direct current power source.

19. An apparatus for video insertion loss compensation comprising:
a coaxial cable of predetermined length;
an analog input video signal transmitted over said coaxial cable;
a video equalizer having an operational amplifier with feedback circuitry comprising a low pass filter with inductance-capacitance characteristics at the low frequencies and dissipative at the higher frequencies, said low pass filter having a coil with a ferrite core and at least one winding in said feedback circuitry for tailoring broadband response of said operational amplifier to generate a compensated video signal from said input video signal;
an output device for outputting said compensated video signal.

20. An apparatus for video insertion loss compensation comprising:
a coaxial cable of predetermined length;
an analog input video signal transmitted over said coaxial cable;
a video equalizer having an operational amplifier with feedback circuitry comprising a low pass filter with inductance-capacitance characteristics at the low frequencies and dissipative at the higher frequencies, said low pass filter having a coil with a high impedance ferrite core at the low to medium frequencies and at least one winding in said feedback circuitry for tailoring broadband response of said operational amplifier to generate a compensated video signal from said input video signal;
an output device for outputting said compensated video signal.

21. A method for video insertion loss compensation comprising:
obtaining a coaxial cable of predetermined length;
transmitting an analog input video signal over said coaxial cable;
generating a compensated video signal from said input video signal using a video equalizer having an operational amplifier with feedback circuitry comprising a low pass filter with inductance-capacitance characteristics at the low frequencies and dissipative at the higher frequencies in said feedback circuitry for tailoring broadband response of said operational amplifier;
outputting said compensated video signal on an output device.

22. The method of claim 21 wherein said coaxial cable is a high resolution cable.

23. The method of claim 21 wherein said analog input video signal is a composite video signal.

24. The method of claim 21 wherein said analog input video signal is a color component of a color system.

25. The method of claim 21 wherein said operational amplifier is of the current feedback type.

26. The method of claim 21 wherein said low pass filter has a coil with a ferrite core with at least one winding.

27. The method of claim 26 wherein said ferrite core has high impedance characteristics at the low to medium frequencies.

28. The method of claim 26 wherein said ferrite core has a size in relation to said predetermined length of said coaxial cable.

29. The method of claim 28 wherein said size of said ferrite core is selected to provide the same insertion loss characteristics over a desired frequency range as said coaxial cable of predetermined length.

30. The method of claim 29 wherein said frequency range is in the low to medium frequency spectrum of a broadband video signal.

31. The method of claim 21 wherein said low pass filter compensates for the low to mid frequency insertion loss of said coaxial cable.

32. The method of claim 31, further comprising compensating for the high frequency range of said broadband video signal with a high bandwidth compensator.

33. The method of claim 32 wherein said compensator for said high frequency range comprises a voltage variable capacitance diode circuit with a variable capacitor for adjusting said bandwidth of said compensator.

34. The method of claim 32 wherein compensator for said high frequency and said low to medium frequency range are independently adjustable.

35. The method of claim 21 wherein said equalizer is located before said coaxial cable.

36. The method of claim 21 wherein said equalizer is located after said coaxial cable.

37. The method of claim 26 wherein said ferrite core is partially saturated from a direct current power source.

38. The method of claim 26 wherein said ferrite core is fully saturated from a direct current power source.
